(19) United States
(12) Patent Application Publication
(10) Pub. No.: US 2002/0096578 A1
(43) Pub. Date: Jul. 25, 2002

(54) Megasonic cleaning device and process

(75) Inventor: Muhammed Mekki Al-Jiboory, Vancouver (CA)

Correspondence Address: KATTEN MUCHIN ZAVIS, Suite 1600, 525 West Monroe Street, Chicago, IL, 60661, US

(73) Assignee: DYNAMOTIVE TECHNOLOGIES CORPORATION

(21) Appl. No.: 09/768,734

(22) Filed: Jan. 24, 2001

(51) Int. Cl. B08B 3/02; B05B 1/08

(52) U.S. Cl. 239/102.1; 134/1; 134/198

(57) ABSTRACT

A megasonic cleaning device and process for cleaning the surfaces of various substrates, such as semiconductor wafers, flat panel displays and the like. The megasonic cleaning device includes a piezo-electric cylindrically focused transducer that is configured with its converging side in contact with the cleaning fluid. The surface of the substrate to be cleaned is located at the focal zone of the transducer. As such, cylindrical acoustical waves generated by the transducer converge at the focal zone where high turbulence and high shear forces are generated in many directions to provide thorough cleaning of the surface, located within the focal zone.

### BACKGROUND OF THE INVENTION

1. Field of the Invention

The present invention relates to a megasonic cleaning device and process which includes a focused transducer configured such that the converging side of the transducer is in contact with the cleaning fluid to provide converging acoustical waves at the surface of a device to be cleaned located at the focal zone of the transducer.

2. Description of the Prior Art

With the development in the semiconductor manufacturing industry, more complex devices and microelectronics are incorporated into the semiconductor wafer. In addition, decreasing the size of these devices makes the requirements for the cleanliness of the wafer more stringent. Furthermore, the industry is continuously increasing the size of the wafer (currently, the diameter of a single silicon wafer is 300 mm), and therefore, more individual devices are incorporated on a single wafer. Complex devices became more valuable, and unsatisfactory levels of cleanliness represent very significant loss of revenue. Therefore, achieving high level of cleanliness would result in significant value to the industry.

Semiconductor surfaces must be ultra-clean before various processes can be applied to the wafer. Currently, there are at least 400 processes for making a high-density chip, and 80 processes involve cleaning. Cleaning is required after sawing, lapping, planarization, polishing, and before metalization, CVD, epitaxy, resist application, and ion implantation. For instance, in the chemical and mechanical planarization (CMP), a slurry of small abrasive particles is used for grinding and polishing wafers. After CMP, particles must be removed from the surface before the next process starts.

In the fabrication of flat display panels (LCD), both organic and inorganic contaminants must be completely removed from the surface of the glass substrate before the patterns are formed on the substrate. The miniaturization of these patterns requires higher levels of cleanliness. Similarly, in the fabrication of compact discs (CD) or magnetic storage discs (HD), both sides of such discs must be thoroughly cleaned before films of various materials can be deposited on the substrates.

Contaminants are removed by a variety of mechanisms including ultrasonic, Megasonic, high pressure spraying, and mechanical scrubbing (brushing). For instance, brushing and spraying are often used for cleaning silicon wafers post-CMP. This process is slow and still requires another step of cleaning to achieve the desired level of cleanliness.

The use of Megasonic cleaning is more efficient than ultrasonic cleaning for submicron particle removal because the cleaning is accomplished via different mechanism than ultrasonic cavitation. When applied parallel to the surface of the wafer, Megasonic waves move the contaminant particles back and forth until they are dislodged from the surface and there is no need for aggressive cavitation, which can cause an adverse damage to the surface.

Low intensity Megasonic systems are found to be ineffective when the substrate is contaminated with particles having a range of sizes. This is generally limited by the operating frequency and acoustic (Megasonic) intensity. Also, larger particles on the substrate surface can shield smaller particles, and therefore, reduce the efficiency of the system.

Generally, there are two types of Megasonic cleaning systems known in the art; submersion cleaning and spin cleaning. Submersion cleaning systems are the first generation of Megasonic cleaning systems used for cleaning wafers and other flat substrates. In this batch cleaning system, multiple wafers are mounted onto a cassette and immersed in a cleaning tank containing DI water only, or mixed with other cleaning additives. A Megasonic transducer is usually fitted at the bottom or on the sides of the tank. The wafers are generally cleaned for long periods of time between 20-30 minutes. The cleaning mechanism of this kind of systems relies on the propagation of the acoustic wave parallel to the surface to be cleaned, and resulting in “moving” the contaminant particles back and forth and therefore, generate enough shear force that results in dislodging the particles from the surface of the substrate and into the bulk of the cleaning solution. The prior art describes a variety of designs and improvements of such cleaning system, but they all rely on the same cleaning mechanism.

Because the acoustic waves are generated near the edge of the wafers, and propagate toward the center of the wafers, the cleaning of the wafers with this system is inhomogeneous, and is generally higher near the edge than near the center of the wafer. Another disadvantage of such system is the re-deposition of the contaminant particles back on the wafer surface as these particles move with cleaning solution. Another disadvantage of this system is the use of large volumes of the cleaning solution.

Since these systems operate only in a batch mode, they become a bottleneck for semiconductor manufacturing as all other manufacturing processes are single-wafer. Examples of such devices and processes are disclosed in: WO 00/27552, WO 00/27551, WO 00/21692, U.S. Pat. No. 5,037,481, U.S. Pat. No. 4,543,130, U.S. Pat. No. 5,593,505, U.S. Pat. No. 5,626,159, U.S. Pat. No. 5,656,097, U.S. Pat. No. 5,672,212,U.S. Pat. No. 5,698,040, U.S. Pat. No. 5,762,084, U.S. Pat. No. 5,839,460, U.S. Pat. No. 5,849,091, U.S. Pat. No. 5,908,509,U.S. Pat. No. 5,911,232, U.S. Pat. No. 5,950,645, U.S. Pat. No. 6,006,765, WO 95/02473, all hereby incorporated by reference.

The second generation of Megasonic cleaning systems is the spin-clean system. This system is fitted with a Megasonic nozzle of various designs, and the wafer is mounted horizontally on a rotating holder or table and span at certain speed. A nozzle producing a liquid jet is mounted above the wafer and scanned across the rotating wafer. The nozzle contains a low power PZT transducer, which produces Megasonic waves transmitted through the liquid jet to the surface of the wafer. Some designs use focused transducers while others use unfocussed transducers. Generally, these nozzles produce low Megasonic energy, and therefore, are limited to applications where only light cleaning is required.

The disadvantages of such cleaning systems are that only one side of the wafer is cleaned at a time. In addition, when one side is being cleaned, the contaminants that come off the topside can contaminate the opposite side of the wafer. Moreover, because of the low Megasonic energy of the nozzle, the cleaning process is relatively slow.

Because these systems clean the substrate in the horizontal orientation only, there is a potential that some of the contaminants remain on the surface of the substrate and within the trenches and crevices of the microelectronics on the surface of the wafer.

There are two types of Megasonic nozzles that have been used in this type of cleaning system, spot nozzle and line nozzle. The first type uses a circular PZT transducer element, and therefore, produces a circular jet of small diameter, which makes a small cleaning spot on the surface of the wafer. The second type uses a long PZT transducer element, which produces a line-like jet and makes a narrow and long area on the surface of the wafer.

Some patents in the art claim the generation of cavitation at the focal point of the spot nozzle, while others just claim high Megasonic intensity without cavitation. Examples of such systems are disclosed in: U.S. Pat. No. 5,927,306, U.S. Pat. No. 5,906,687, U.S. Pat. No. 5,980,647, U.S. Pat. No. 6,021,785, U.S. 5,339,842, U.S. Pat. No. 5,100,476, U.S. Pat. No. 5,562,778, JP1111337, JP8117711, JP10223589, JP10151422, JP20207001, JP1095521, JP11028432, JP4104872, JP1297186, JP62122132, JP6320125, JP6124935, JP7232143, JP10107001, all hereby incorporated by reference.

Other cleaning systems that use the line nozzle can cover larger surface area of the substrate than the spot nozzle. Systems with nozzles include focused and unfocused transducers.

Unfocused flat (plate) transducers produce plane wave fronts, which, when concentrated (using reflectors), will still form plane waves in the focal zone. The “concentrated” plane waves, however, produce lower turbulence than the focused cylindrical waves. Systems with unfocused transducers are formed from long piezo-electric transducer elements, generate converging acoustical waves at a focal line. Unfortunately, such systems are also configured such that the substrate is disposed outside of the focal line, where the cleaning effectiveness is greatly reduced. Examples of such systems are disclosed in Japanese laid open patent applications; JP 7283183; JP 11267598; JP 9171986; JP 8267028; JP 393230; JP 7100434; JP 9330896; JP 10296199; JP 697143; JP 10189528.

Japanese laid open patent application JP8281230 discloses a cleaning system which utilizes a flat transducer and a reflector mirror to focus the acoustical waves at the exit port of the nozzle. The system is configured such that the systems to be cleaned is located at a distance from the focal lens where the cleaning effectiveness of the acoustical waves is reduced.

Cleaning systems are also known which utilize a line nozzle which includes a cylindrically focused lens attached to a flat transducer. In such systems, cylindrically focused acoustic waves are generated. These cylindrical acoustical waves converge at a focal zone located either inside, near or at the exit port of the nozzle. In such systems, the substrate to be cleaned is located away from the focal zone where the cleaning effectiveness is greatly reduced. Examples of systems with focusing lenses in which the substrate is disposed away from the focal zone are disclosed in Japanese laid open patent applications JP 710 6651; JP 5269450; JP 760210 and JP 7100434.

Another issue with such cleaning systems relates to horizontal vs. vertical cleaning. When cleaning the substrate horizontally (the substrate plane is horizontal), it is very likely that some of the contaminants (particularly the small ones) will remain or re-deposit on the substrate within the trenches of the microelectronics on the surface of the substrate. In addition, if the nozzle is tilted at an angle with respect to the substrate, and the substrate moves opposite to the direction of the liquid jet, there is still a chance that some of the contaminated liquid will be carried over on the cleaned side of the substrate (passed the nozzle). This results in reducing the cleaning efficiency of the system.

In general, horizontal cleaning of substrates is an inefficient cleaning method since there is a chance that some of the dislodged contaminants, which are carried by the liquid flow, will be re-deposited back on the substrate surface. Examples of such horizontal cleaning systems are disclosed in: U.S. Pat. No. 4,326,553, U.S. Pat. No. 5,975,098, U.S. Pat. No. 6,021,789, U.S. Pat. No. 6,039,059, U.S. Pat. No. 5,601,655, WO 87/06862, JP7106651, JP7283183, JP327671, JP11267598, JP9171986, JP8267028, JP393230, JP5269450, JP760210, JP7100434, JP9330896, JP10296199, JP10189528, JP8281230, all hereby incorporated by reference.

U.S. Pat. No. 5,975,098 discloses a Megasonic cleaning system of flat display panels. In this application, only one side of the substrate is cleaned. The system consists of a long Megasonic nozzle combined with a high-pressure rinse nozzle. The long Megasonic nozzle produces a curtain-like jet with Megasonic energy. Again, the horizontal cleaning can cause re-deposition of contaminant particles on the cleaned surface. For cleaning both sides of the substrate, the substrate must be turned over after cleaning one side. This results in recontaminating the cleaned surface. The Megasonic transducer used in the nozzle is a flat unfocussed PZT element that produces longitudinal plane waves that are “projected” to form a narrow line of Megasonic energy. The Megasonic energy used here is to aid the liquid jet to remove the contaminants. Some of this energy is wasted by reflection and absorption by the inner walls of the nozzle body. The low Megasonic energy of this transducer will make this system slow and limited to cleaning applications that only require gentle cleaning.

### SUMMARY OF THE INVENTION

The present invention relates to a megasonic cleaning device and process for cleaning the surfaces of various substrates, such as semiconductor wafers, flat panel displays and the like. The megasonic cleaning device includes a piezo-electric focused transducer that is configured with its converging side in contact with the cleaning fluid. The surface of the device to be cleaned is located at the focal zone of the transducer. As such, acoustical waves generated by the transducer converge at the focal zone where high turbulence and high shear forces are generated in many directions to provide thorough cleaning of the surface, located within the focal zone.

### DESCRIPTION OF THE DRAWINGS

These other advantages of the present invention will be readily understood with reference to the following specification and attached drawing wherein:

FIG. 1 is an end elevational view of a megasonic cleaning device in accordance with the present invention, shown with a vertically suspended device to be cleaned, located in the focal zone of an exemplary cylindrically focused transducer which forms part of the megasonic cleaning device in accordance with the present invention..

FIG. 2 is a perspective view of a megasonic cleaning device illustrated in FIG. 1.

FIG. 3A is similar to FIG. 1, but illustrating two megasonic cleaning devices configured in accordance with the present invention to provide two sided vertical cleaning of a device to be cleaned.

FIG. 3B is similar to FIG. 3a but illustrating two sided horizontal cleaning.

FIG. 4A is a cross sectional view in elevation of an exemplary cylindrically focused transducer in accordance with the present invention, formed from one or more curved piezo-electric elements.

FIG. 4B is a top view of the transducer illustrated in FIG. 4A.

FIG. 5A is a cross sectional view in elevation of an alternate embodiment of a cylindrically focused transducer in accordance with the present invention, formed from multiple curved piezo-electric elements.

FIG. 5B is a top view of the transducer illustrated in FIG. 5A.

FIG. 6A is a cross sectional view in elevation of another alternate embodiment of a cylindrically focused transducer, formed from one or more piezo-electric transducers, attached to a curved membrane in accordance with the present invention.

FIG. 6B is a top view of the transducer illustrating in FIG. 6A.

FIG. 7 is another alternate embodiment of the transducer in accordance with the present invention formed from one or more piezo-electric transducers, attached to a piano cylindrical focusing lens.

FIGS. 8A and 8B illustrate different cleaning fluid inlet port configurations for the megasonic cleaning device in accordance with the present invention.

FIG. 8C is another alternate configuration for the cleaning fluid inlet ports.

FIGS. 9A and 9B illustrate different orientation configurations of a cylindrically focused nozzle in accordance with the present invention, relative to a vertically oriented substrate.

FIG. 10 is a process diagram for the megasonic cleaning device in accordance with the present invention illustrating the fluid path for the cleaning solution for a cleaning process which utilizes the megasonic transducers in accordance with the present invention.

### DETAILED DESCRIPTION

The present invention relates to a megasonic cleaning device which includes a cylindrically focused transducer. An important aspect of the invention is that the transducer within the megasonic cleaning device is configured such that the converging side of the transducer is disposed in contact with the cleaning fluid. By so configuring the transducer, the transducer generates converging acoustic waves which converge at a focal point or zone. The converging waves generate relatively high turbulence in the focal zone, thus creating relatively high shear forces in many directions to thoroughly clean any contaminated surfaces, such as a semiconductor wafer, flat panel display, hard disk, LCD panel, CD or other device, hereinafter referred to as a substrate located in the focal zone.

The configuration of the megasonic cleaning device provides various advantages over known megasonic cleaning systems. For example, acoustical energy losses due to reflections and absorptions are minimized since most of the energy generated by the transducer is converged at the focal zone without the need for reflectors or lenses. In addition, the acoustic intensity of the acoustic waves is relatively uniform over the surface area of the surface to be cleaned in order to achieve uniform cleaning of the entire surface to be cleaned. Another advantage of the system in accordance with the present invention is that it is relatively compact since focused transducers have a smaller footprint and therefore take up less space than unfocused planewave transducers.

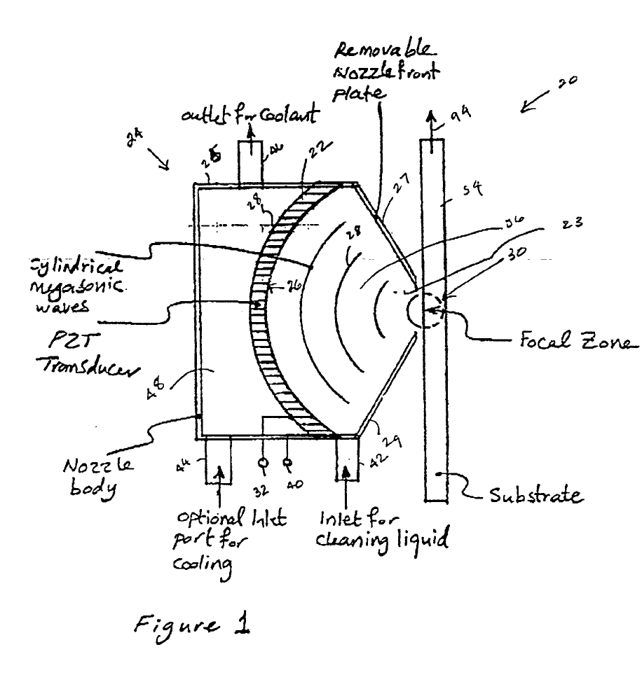

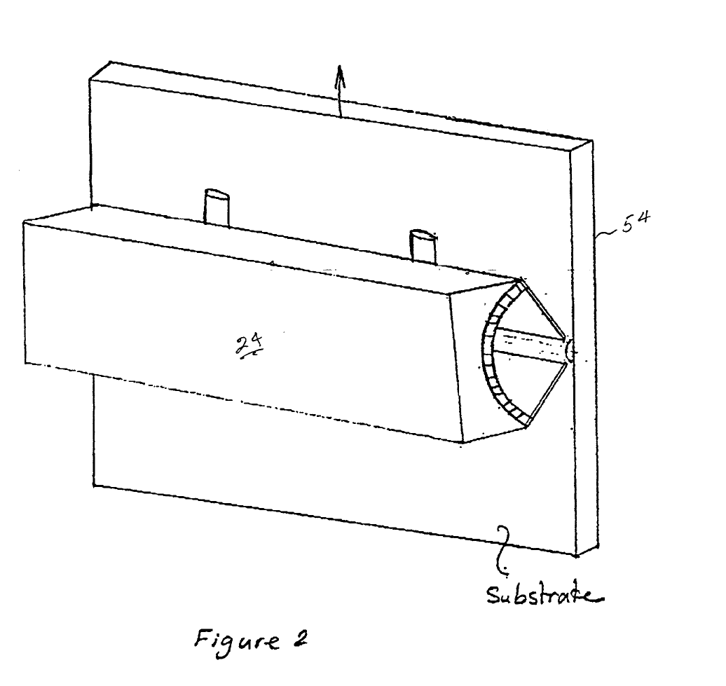

An exemplary megasonic cleaning device in accordance with the present invention is generally illustrated in FIGS. 1 and 2 and generally identified with the reference numeral 20. As shown, in FIGS. 1 and 2, the megasonic cleaning device 20 includes a cylindrically formed piezo electric transducer 22, located within a housing or nozzle 24. The piezo electric transducer 22 is configured such that the converging side of the transducer 22 is in contact with the cleaning fluid so that converging cylindrical acoustical waves 28 will be generated at a focal zone, generally identified with the reference numeral 30, located at least partially outside of the nozzle 24.

As is known in the art, the focal zone of an acoustic transducer, such as a piezo-electric transducer, is a function of the frequency of the electric power source applied to the transducer and the radius of curvature of the transducer. Referring to FIG. 1, electric power is applied to the transducer 22 by way of the terminals 32 and 40. Thus, the focal zone 30 can be controlled by varying the frequency of the electrical power applied to the terminals 32 and 40. The frequency range of the system may be between 10 kHz to 20 MHz. At low and midrange frequencies (i.e. 100-500 kHz) cavitation within the focal zone 38 can be turned on and off by controlling the power to the transducer 22.

Referring to FIG. 1, the nozzle 24 includes a rear nozzle housing portion 25, which may be open on one end and closed by a pair of nozzle front plates 27 and 29, which may be removable. The front nozzle plates 27 and 29 are each connected on one end of the mouth of the rear nozzle housing portion 25 with the opposing sides separated by a distance slightly larger than the focal point 30 of the transducer 22 to form a cleaning fluid outlet port 23. The removable nozzle front plates 27 and 29 allow access to the piezo electric transducer 22 while also forming a portion nozzle.

The nozzle 24 also includes one or more inlet ports 42 for receiving a cleaning fluid. The inlet ports 42 is disposed such that the cleaning fluid is in contact with the converging side 26 of the transducer 22, as discussed above. The cleaning fluid can be dionized water either by itself or mixed with basic or acidic additives that promote cleaning. Surfactants can be added at relatively small concentrations to help in cleaning and rinsing the surface. The temperature of the cleaning fluid can vary between 80° to 180° F.

The megasonic transducer 20 may require cooling when used at relatively high power levels or when used with a relatively hot cleaning fluid. As such, optional cooling fluid inlet and output ports 44 and 46 may be provided. These cooling fluid ports 44 and 46 may be located at the rear of the nozzle body 24 so as to enable a cooling fluid to be in contact with the back or diverging side 28 of the transducer 22. Various cooling fluids are suitable, such as liquid or gas, which may be circulated through a cavity 48, formed by the back of the transducer 22 and the rear of the nozzle body 24. However, when cold or warm cleaning fluids are used, there may not be a need for additional cooling fluid which case the cleaning fluid in acts as a coolant.

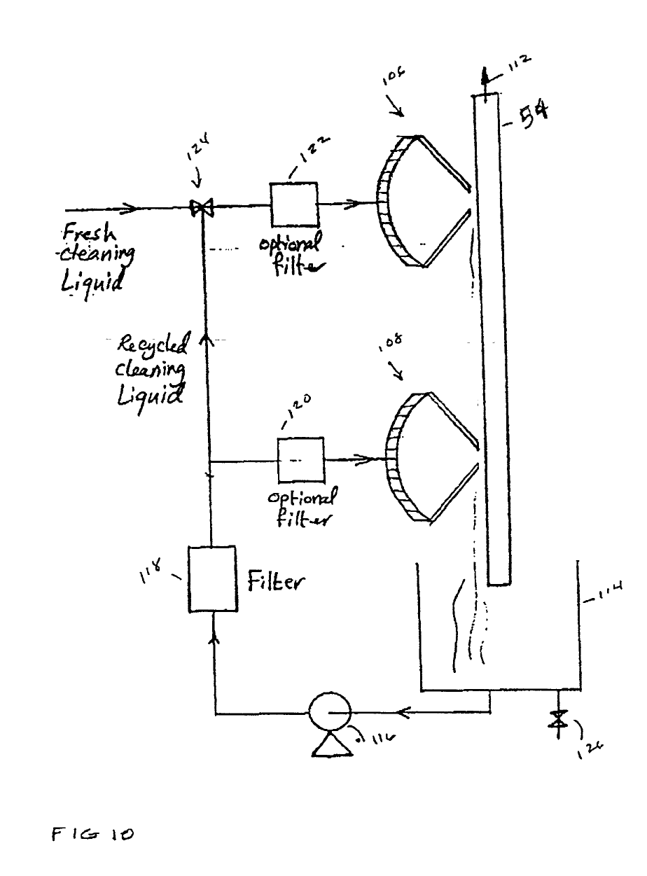

An important aspect of the invention is at the focal zone 30 of the transducer is located at least partially outside of the nozzle 24 such that a substrate 54 can pass through at least a portion of the focal zone 30 without contacting the front plates 27 and 29. Preferably the substrate 54 is passed through the middle of the focal zone 30, as shown in FIG. 1. As such, the maximum acoustic intensity is achieved in the middle of a focal zone 30 and therefore maximum cleaning effectiveness is provided to the substrate 54. Due to the positive pressure generated by the flow of cleaning fluid out of the cleaning fluid outlet port 23, any contaminants removed from the substrate 54 are generally prevented from entering the cavity 56, formed between the removable nozzle front plates 27 and 29 and the converging side 26 of the piezo electric transducer 22. As such, contaminants that are removed from the substrate 54 to be cleaned are carried by the fluid flow and gravity to an area beneath the device as discussed below in connection with FIG. 10.

Cylindrically focusing transducers are contemplated for use with the invention. Such transducers generate cylindrical waves which are focused toward the focal zone where the substrate to be cleaned is located. The cylindrical waves inside the focal zone generate higher shear forces on the substrate surface than plane waves generated by unfocused or plane transducers.

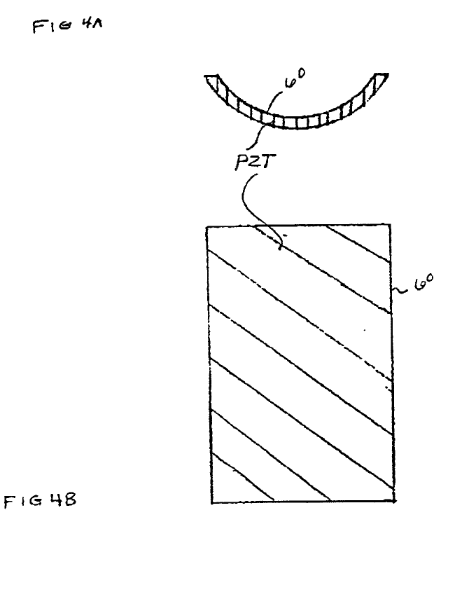

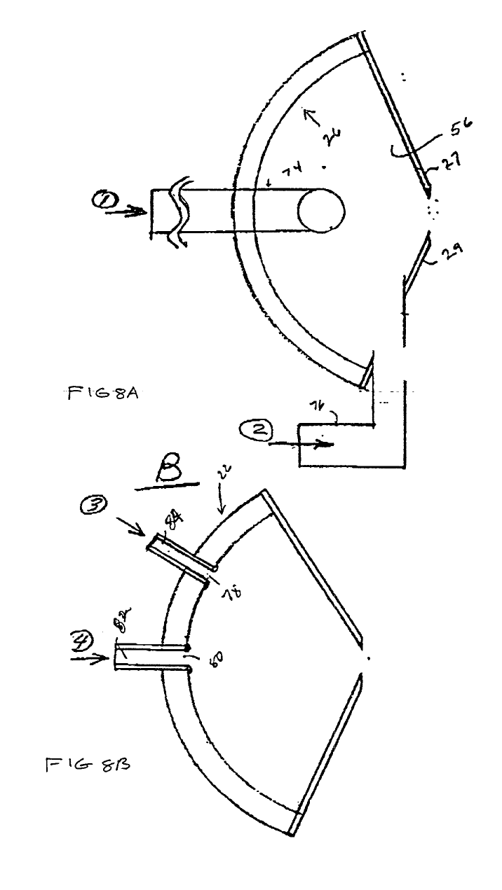

FIGS. 4-6 illustrates various embodiments of a cylindrically focused piezo electric transducer 22 in accordance with the present invention. The piezo electric transducer 22 may be formed by either shaping piezo electric transducer elements into a cylindrical, as illustrated in FIG. 4, or by attaching a focusing lens 72 to a flat dielectric transducer, as illustrated in FIG. 7.

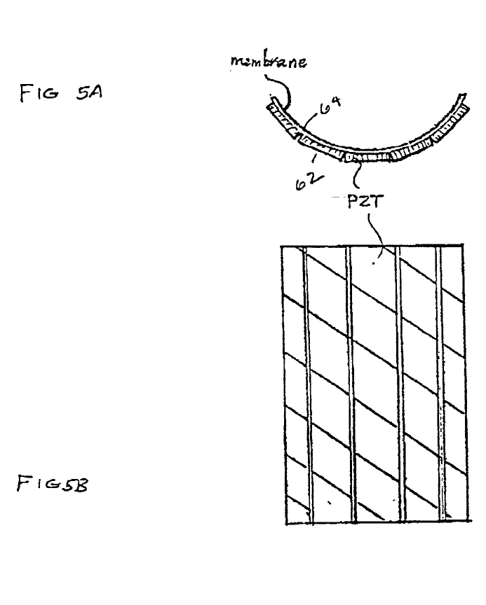

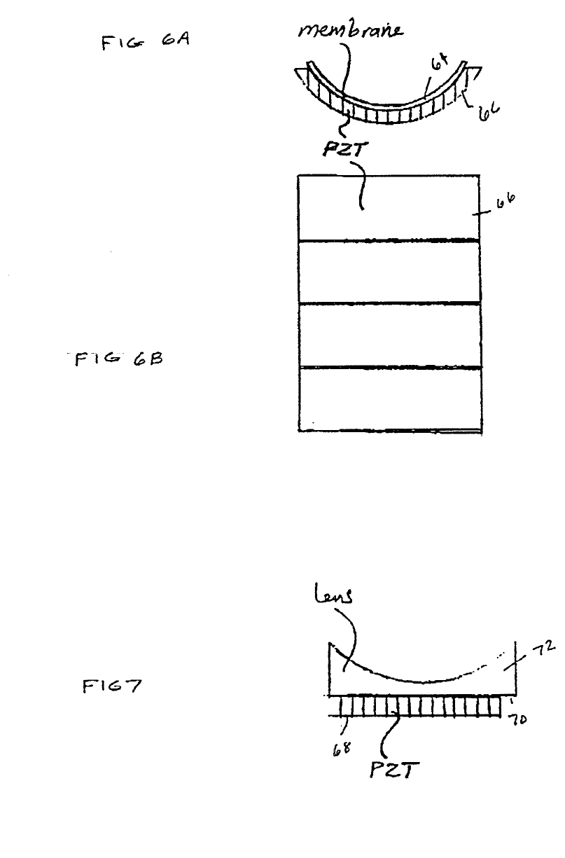

In particular, FIGS. 4A and 4B represent a first exemplary embodiment in which the transducer 22 is formed from one or more curved piezo electric elements 60 attached together to form a section of a cylinder as shown. FIGS. 5A and 5B illustrate another alternate embodiment in which the transducer 22 is formed from multiple curved piezo electric elements 61, attached to a relatively thin curved membrane 64, formed in the shape of a section of a cylinder. The curved membrane 64 may be formed from metal or ceramic. FIGS. 6A and 6B represent another exemplary alternate embodiment in which the transducer 22 is formed from one or more flat piezo electric elements 66, attached to a membrane, such as the membrane 64. Lastly, FIG. 7 illustrates one or more flat piezo electric elements 68 attached to a flat side 70 of a plano cylindrical focusing lens 72. In this embodiment, the focal zone 30 is determined by the characteristics of the plano cylindrical focusing lens 72. More particular, the focal zone 30, for the embodiment illustrated in FIG. 7 will be at the focal point of the lens 72.

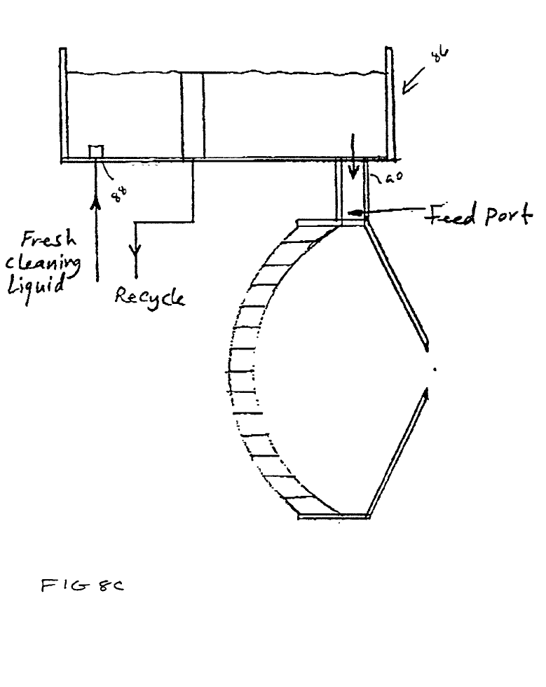

FIGS. 8A-8C illustrate alternate configurations for the cleaning fluid inlet ports. As shown in FIG. 8A, one or more inlet cleaning fluid ports 74 and 76 may be provided. As shown, the inlet port 74 may be disposed to direct the cleaning fluid in the cavity 56 formed by the removable nozzle front plates 27 and 29 and the converging side 26 of the transducer 22. The nozzle 76 is disposed so that the direction of fluid flow is essentially directed at an angle generally normal to the direction of fluid flow from the cleaning fluid inlet port 74. The nozzle 76 is formed with an opening in one of the removable nozzle front plates 27 and 29.

Alternately, as shown in FIG. 8B, one or more openings 78 and 80 may be formed in the transducer 22. One or more inlet ports 82 and 84 may be disposed within these openings 78 and 80 so that the cleaning fluid is directed to the cavity 56 as mentioned above.

FIG. 8C illustrates another alternate embodiment which includes a separate cleaning fluid reservoir tank 86, disposed outside of the nozzle body 24. In this embodiment, the cleaning fluid reservoir 86 includes an inlet port 88 for cleaning fluid and an outlet port 90 that is in communication with the cavity 56.

An important aspect of the invention is that the megasonic cleaning device 20 may be used in various configurations for single sided, double sided, horizontal or vertical cleaning of the surfaces of various devices. For example, as illustrated in FIGS. 1 and 2, a single megasonic cleaning device 20 is illustrated such that the cleaning fluid outlet port 23 points horizontally. In this configuration, the surface of the device 54 to be cleaned is adapted to be moved vertically relative to the cleaning fluid outlet port in the direction of the arrow 94.

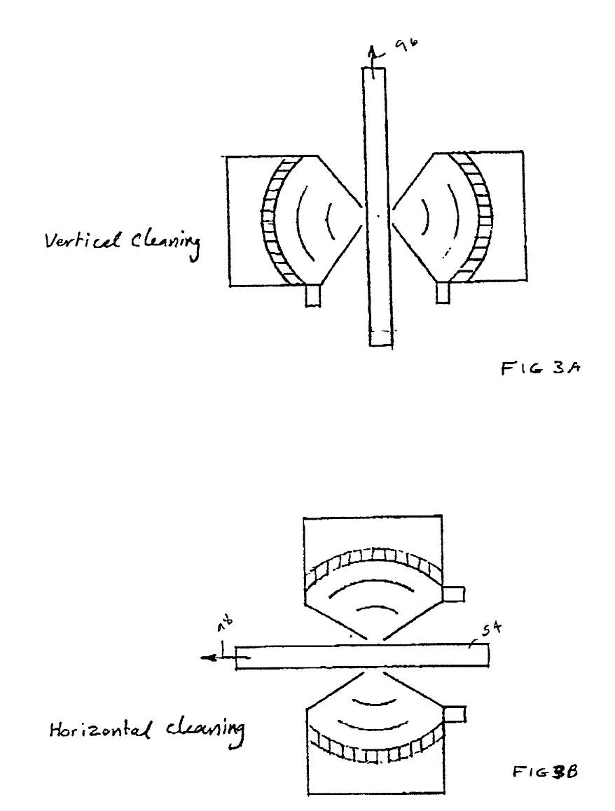

As illustrated in FIG. 3A, two megasonic cleaning devices 20 can be configured to provide two sided vertical cleaning of the device 54. In this embodiment, the cleaning fluid outlet ports 23 of two megasonic cleaning devices 20 are configured to point horizontally toward each other. The surface of device 54 is moved vertically relative to the cleaning fluid outlet ports 23 in the direction of the arrow 96.

FIG. 3B illustrates another alternate embodiment in which two megasonic cleaning devices 20 are oriented such that there cleaning fluid outlet ports 23 point vertically and toward each other. In this embodiment, the surface of the device 54 to be cleaned is moved horizontally in the direction of the arrow 98.

Alternatively, a single nozzle can be used for horizontal cleaning with the cleaning fluid outlet port 23 pointing upwards or downwards. In such embodiments, the device 54 is moved horizontally through the focal zone. In other embodiments, a single set of nozzles can be used for cleaning a device in a single stage while a second set can be used following the first set for either a final rinse or for cleaning heavily contaminated device.

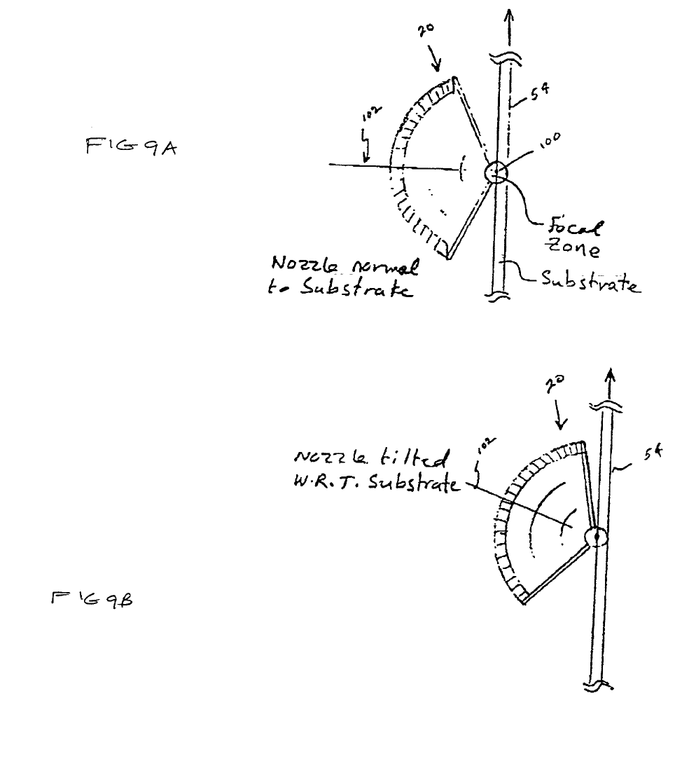

Various orientations of the nozzle are also contemplated is illustrated in FIGS. 9A and 9B. In particular, as shown in FIG. 9A, the nozzle 24 is configured such that a line 102 bisecting the nozzle 20 generally parallel to the direction of fluid flow from the cleaning fluid outlet port 23 is generally perpendicular to the surface to be cleaned. Alternatively, the nozzle 24 can be slightly tilted as shown in FIG. 9B such that the line 102 is not perpendicular to the surface of the device 54 to be cleaned.

FIG. 10 illustrates the entire megasonic cleaning device 20 as well as the cleaning process. As shown, two megasonic nozzles 106 and 108 are configured to provide a two stage one sided cleaning process as discussed above. In this application, the surface of the device 54 to be cleaned 54 is moved vertically in the direction of the arrow 112. Various other configurations are possible as discussed above. In the configuration illustrated, a collection tank 114 is located beneath the device 54 to be cleaned and the megasonic transducers 106 and 108. Contaminated cleaning fluid is collected in the collection tank 114 and recycled by way of a pump 116, and directed to one or more filters 118, 120 and 122 to form a closed loop cleaning system. Suitable filters may be used to filter out undesired particle sizes from the cleaning fluid. In this way, the contaminated cleaning fluid can be filtered and recycled back to the megasonic transducers 106 and 108.

A three way valve 124 may be provided which allows clean cleaning fluid to be introduced into the system. Initially, the valve 128 may be opened to allow sufficient cleaning fluid into the closed loop, at which time the valve 128 is closed. Once the valve 128 is closed, the system may be operated in a closed loop mode to allow the cleaning fluid to be recycled after appropriate filtering.

A drain valve 126 may be provided on the bottom of the collection tank 114. The drain valve 126 may be used for maintenance and clean up of the system.

Obviously, many modifications and variations of the present invention are possible in light of the above teachings. Thus, it is to be understood that, within the scope of the appended claims, the invention may be practiced otherwise than as specifically described above.

What is claimed and desired to be secured by Letters Patent of the United States is:

We claim:

1. A megasonic cleaning device for cleaning the surface of a predetermined substrate, the megasonic cleaning device comprising:
a nozzle formed with a front cavity and a rear cavity having an opening forming a cleaning fluid outlet port;
a cylindrically focused transducer defining a converging side, the transducer disposed in said nozzle such that said converging side is in contact with a cleaning fluid, said transducer configured to generate cylindrically converging acoustic waves at a focal zone, wherein said nozzle is configured such that said focal zone is at least partially disposed outside said nozzle; and
one or more cleaning fluid inlet parts, disposed to be in communication with said front cavity and said cleaning fluid outlet port.

2. The megasonic cleaning device as recited in claim 1, wherein said cylindrically focused transducer includes one or more curved piezo-electric elements coupled together to form a portion of a cylinder.

3. The megasonic cleaning device as recited in claim 1, wherein said cylindrically focused transducer includes a plurality of curved piezo-electric elements and a thin membrane, formed in the shape of a portion of a cylinder, said plurality of piezo-electric elements attached to said membrane.

4. The megasonic cleaning device as recited in claim 1, wherein said cylindrically focused transducer includes one or more flat piezo-electric elements and a thin membrane formed in the shape of a portion of a cylinder, said plurality of piezo-electric elements attached to said membrane.

5. The megasonic cleaning device as recited in claim 1, wherein said cylindrically focused transducer includes one or more flat piezo-electric elements attached to an acoustical lens.

6. The megasonic cleaning device as recited in claim 5, wherein said acoustical lens is a plano-cylindrical focusing lens.

7. The megasonic cleaning device as recited in claim 1, further including one or more cooling ports for cooling said transducer.

8. The megasonic cleaning device as recited in claim 7, wherein said cooling ports are configured to be in communication with said rear cavity.

9. A megasonic cleaning system for cleaning one or more surfaces of a substrate, the megasonic cleaning system comprising:
one or more megasonic cleaning devices, each megasonic cleaning device including a cylindrically focused transducer having a converging side and configured such that said converging side is in communication with a cleaning fluid.

10. The megasonic cleaning system as recited in claim 9, wherein said megasonic cleaning device is configured to enable vertical cleaning of a surface of a substrate.

11. The megasonic cleaning system as recited in claim 9, wherein said megasonic cleaning device is configured to enable horizontal cleaning of a surface of a substrate.

12. The megasonic cleaning system as recited in claim 10, further including one or more additional megasonic cleaning devices.

13. The megasonic cleaning system s recited in claim 12, wherein said megasonic cleaning device and said one or more additional megasonic cleaning devices are configured t o be disposed on the same side of the surface to be cleaned.

14. The megasonic cleaning system as recited in claim 13, wherein said megasonic cleaning devices and said one or more additional megasonic cleaning devices are configured for horizontal cleaning.

15. The megasonic cleaning system as recited in claim 13, wherein said megasonic cleaning devices and said one or more additional megasonic cleaning devices are configured for vertical cleaning.

16. The megasonic cleaning system as recited in claim 12, wherein said megasonic cleaning device and said one or more additional megasonic cleaning devices are configured to be disposed on the different side of the surface to be cleaned.

17. The megasonic cleaning system as recited in claim 16, wherein said megasonic cleaning devices and said one or more additional megasonic cleaning devices are configured for horizontal cleaning.

18. The megasonic cleaning system as recited in claim 16, wherein said megasonic cleaning devices and said one or more additional megasonic cleaning devices are configured for vertical cleaning.

19. A megasonic cleaning system for cleaning one or more substrates, the megasonic cleaning system comprising;
one or more megasonic cleaning devices, each cleaning device including a nozzle and a cylindrically focused transducer for generating cylindrically converging acoustic waves at a focal zone, said nozzle having an outlet port for discharging fluid along a predetermined axis, wherein said nozzle is configured such that said focal zone is disposed at least partially outside said outlet port.

20. The megasonic cleaning system as recited in claim 19, wherein said megasonic cleaning device is configured such that said predetermined axis is generally perpendicular to the surface of said substrate.

21. The megasonic cleaning system as recited in claim 19, wherein said megasonic cleaning device is configured such that said predetermined axis is generally not perpendicular to the surface of said substrate.

22. A process for cleaning a surface of a device to be cleaned comprising the steps of:
(a) generating cylindrically converging acoustic waves which converge at a focal zone; and
(b) disposing a surface to be cleaned at said focal zone.
